(19) United States
(12) Patent Application Publication
(10) Pub. No.: US 2007/0024144 A1
(43) Pub. Date: Feb. 1, 2007

(54) Disk alternator

(75) Inventor: Louis Obidniak, Laval (CA)

Correspondence Address: MERCHANT & GOULD PC, P.O. BOX 2903, MINNEAPOLIS, MN, 55402-0903, US

(73) Assignee: TECOBIM INC., Laval (CA)

(21) Appl. No.: 11/495,029

(22) Filed: Jul. 28, 2006

Related U.S. Application Data
(63) Continuation-in-part of application No. 10/911,867, filed on Aug. 5, 2004, now abandoned.

(30) Foreign Application Priority Data
Aug. 5, 2003 (CA) CA 2,436,369

(51) Int. Cl. H02K 21/12; H02K 31/00; H02K 21/00

(52) U.S. Cl. 310/156.36; 310/178; 310/156.35; 310/268; 310/207

(57) ABSTRACT

A power disk alternator includes a rotor of circular cross-section arranged to rotate about an axis having at least two disks facing each other and defining at least one gap therebetween, and a shaft connected to an external source for driving the shaft in rotation about the axis. Each disk has a circular array of arcuately-spaced magnetized elements located adjacent to its periphery, each of the magnetized elements having surfaces of opposite polarity and being disposed side-by-side in a like polarity configuration. Magnetized elements of one disk face magnetized elements of the other disk of opposite polarity, creating magnetic fields between the opposite polarities in the gap between the two disks. The alternator also includes a stator comprising at least one fixed nonmetallic disk having a conductor path comprising at least one uninterrupted conductor on at least one surface thereof, each stator being located in one of the at least one air gap. A connector is provided for connecting the conductor path to a load. When the external source drives the shaft in rotation, the rotor rotates, and the resulting rotating magnetic field induces a current in the conductor path.

This application is a Continuation-in-part of U.S. patent application Ser. No. 10/911,867 filed on Aug. 5, 2004, which claims priority to Canadian Patent No. 2,436,369 filed on Aug. 5, 2003, and which application(s) are incorporated herein by reference.

### FIELD OF THE INVENTION

The present invention relates generally to dynamoelectric machines, or generators, and more specifically to alternators having substantially ironless stator coils and permanent magnet rotors.

### BACKGROUND OF THE INVENTION

Generator design is becoming increasingly important given continuously increasing demands for lightweight, durable and efficient generators capable of operating at low and high speeds for installations in windmills, diesel engines, reciprocating steam engines and many other similar power generators.

An electric generator is a machine that transforms mechanical energy into electrical energy, i.e. motion into electric current. Basically, an electric generator uses Faraday's law electromagnetic induction: a conductor moving through a magnetic field, or a magnetic field moving past a conductor, induces a motional electromotive force (emf) in the conductor. The direction of the emf is given by Lenz's law: the induced emf in an electric circuit always acts in such a direction as to produce a current whose magnetic field opposes the change in magnetic flux that procuced the emf.

In an alternating current (ac) generator, or alternator, a coil of conductor (e.g. coil of wire) is made to rotate by mechanical means in a uniform magnetic field about an axis perpendicular to the magnetic field, and the changing magnetic flux through the coil induces a sinusoidal, i.e. alternating, current which is the output of the alternator.

Typically, an alternator has at least one multi-turn conducting coil closely wound on an armature. Although the armature can be made to rotate in a magnetic field provided by electromagnets or permanent magnets, the armature and coil assembly is usually stationary and is commonly referred to as the stator. It is the magnetic field provided by the electromagnets or permanent magnets that rotates with respect to the stator. As such, the rotating magnet assembly is commonly referred to as the rotor. The stator armature supports the coil and allows the magnetic field to pass through the conductor coils, and is not an operating member of current generation, unlike the magnetic flux itself.

The frequency of the alternating current in most alternators is directly proportional to the speed of rotation of the rotor. The generated emf induced in the conducting coil can be computed from the rate of change of the magnetic flux through the coil or from the velocity of the coil relative to the rotating magnetic field. This applies to any coil of any shape moving perpendicularly relative to a uniform magnetic field.

Existing alternators, in order to be effective in power conversion, require a high speed of coil movement with respect to the magnetic field. However there are many applications that call for low operating speeds, such as reciprocating power plants, steam or diesel engines, water or windmills, etc. In order to be effective, the output rotation of such power plants must be increased by various mechanical means, representing an additional source of losses and maintenance requirements.

To maximize the magnitude of the magnetic field, and hence the current generated by the alternator, the stator armature of conventional generators/alternators may be made of a magnetically permeable material such as iron. Cores of steel laminations may be used to not only conduct the magnetic flux to the next rotor magnetic pole but to mechanically support the stator coils. Great care is used to reduce eddy currents, heat buildup, by stacking several thin insulated laminations in these armature cores. However, one drawback stems from the magnetically permeable armature core inside the stator coil: this magnetically permeable core exerts an attractive force on the magnetic rotor, causing a resistive force against the rotation of the rotor. Moreover, the magnetically permeable material generally increases the weight of the generator and is a source of losses, owing to the heating, hysteresis and braking (cogging) of moving magnetic fields, all of which can actually reduce the current-generating efficiency of the alternator. A more efficient way to maximize the magnetic field is to increase the number of turns in the conducting coil.

In another type of alternator, the magnetic poles are arranged along the periphery of the rotor (with adjacent magnetic poles alternating in polarity) to increase the radial distance between the magnetic poles and the rotor shaft and thus the torque arm length. A drawback of this type of alternator stems from the magnetic flux return paths required between adjacent magnetic poles. By adding “back-iron” to complete the magnetic circuit, the magnetic volume increases which increases hysteresis and eddy current losses (i.e. core losses) as well as the weight of the alternator thereby decreasing the power-generating efficiency.

Conventional alternators use either a polar-coordinate design concept (angular magnetic flux conduction) or a rectangular-coordinate design concept (axial magnetic flux conduction). In axial magnetic flux conduction, the axis of rotation defines an axial direction and the effective parts of the stator conducting coil extend in a radial direction relative to the axis of rotation and interact with the magnetic flux which extends in the axial direction. For maximum magnetic-flux-generating efficiency, the axial gap, i.e. spacing between opposing magnetic poles that generate axial magnetic flux in the gap, should be as narrow as possible without hindering the relative motion of the stator and rotor. In addition, the stator disk should be as thin as possible, but must retain its rigidity and be free from vibration.

These alternator design concepts have continuously evolved over the last 100 years to the point where today the technology is virtually unchanged. Changes have arisen from improvements in manufacturing techniques and material science. Nevertheless, industrial markets show a considerable need for an alternator capable to operate at low and high speeds.

### SUMMARY OF THE INVENTION

In accordance with an aspect of the present invention, there is provided a power disk alternator comprising:
rotor means arranged to rotate about an axis, having a circular cross section, and comprised of at least two disks facing each other and defining at least one gap therebetween, the rotor means having a shaft connected to an external source for driving the shaft in rotation about the axis;
a circular array of magnetized elements located in equally arcuately spaced relation adjacent to the periphery of each disk, each of the magnetized elements having surfaces of opposite polarity and being disposed in side-by-side relationship in a like polarity configuration, magnetized elements of one disk facing magnetized elements of the other disk of opposite polarity to create between the two disks in the air gap the magnetic fields between opposite polarities; and
stator means comprising at least one fixed disk made of a nonmetallic material having a conductor path on at least one surface thereof, the conductor path comprising at least one uninterrupted conductor wound on the surface, each of the stator means being located in one of the at least one air gap; and
connection means for connecting the conductor path to a load,
   wherein when the external source drives the shaft of the rotor means in rotation about the axis, the rotor means rotates and the resulting rotating magnetic field induces a current in the conductor path of the stator means.

Preferably, the magnetized elements are permanent magnets with north pole surfaces magnetically exposed on a first surface of each disk of the rotor means and south pole surfaces magnetically exposed on a second surface of each disk opposite the first surface, thus advantageously the north pole surfaces of one disk face the south pole surfaces of the other disk creating in the air gap between the two disks the uniform axially-unidirectional magnetic fields between the opposite poles.

In an embodiment of the present invention, the at least one uninterrupted conductor preferably comprises a plurality of conductors connected in series.

In another embodiment of the invention, the at least one uninterrupted conductor preferably comprises a plurality of radial portions extending from the center to the circumferential periphery of the at least one fixed disk, the radial portions being equally spaced.

Also preferably, the conductor path is flat.

In yet another embodiment of the invention, the alternator preferably comprises a number of rotor disks and a number less one stator disks, a stator disk being located in each of the air gaps.

Thus, a preferred object of the present invention is to provide an alternator in which the axial magnetic flux of the rotor means is maintained at its maximum and the conductor looped on the surface of the stator means has no ferromagnetic core so as to reduce eddy currents and associated losses.

Another preferred object of the present invention is to provide an alternator wherein the magnetic field strength is substantially uniform.

Yet another preferred object of the present invention is to provide an alternator wherein the magnetic rotor means set up a substantially unidirectional magnetic field in the air gap between magnetized elements of opposite polarity about the arc of travel, the magnetic fields created between the pairs of magnetized elements of opposite polarity are all along the same axial direction.

An additional preferred object of the invention is to provide an axial gap alternator that is light-weight and achieves high power density.

It is also a preferred object of the invention to obtain a small air gap between the rotor means of the disk alternator by making the fixed disk of the stator means as thin as possible while retaining its rigidity.

Moreover, it is a preferred object of the invention to provide a cost-effective alternator designed to be reliable through all changing operating conditions, namely, to withstand runaway operation and run with minimal maintenance.

Advantageously, the preferred objects of the invention may be achieved through the following unique design features:
direct driven, thus eliminating the need for costly gearboxes;
fewer operating components (no gearboxes, no chain drives etc.), reducing maintenance;
safer operating conditions since there is no step-up gear ratio that can cause the failure of the centrifugal alternator in conventional high-speed alternators;
reduced manufacturing cost given the coreless alternator design;
increased efficiency given the absence of an iron core, specifically the heating of the iron core caused by eddy currents;
easily configurable design, which can be tailored using little redesigning or existing standard components for higher or lower load conditions using a unique “stackable” design methodology;
a flexible design for operating output frequency based on power shaft operating revolutions-per-minute (rpm);
reduced maintenance cost based on simple assembly, and disassembly procedures.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIG. 1 is a partial cross-sectional view of two disk rotors with their permanent magnet assemblies and one disk stator with its at least one uninterrupted conductor between the two disk rotors, according to a preferred embodiment of the invention, illustrating the flow of the unidirectional magnetic field produced by the rotation of the disk rotor magnets and the current induced in the disk stator conductor. For clarity of view, the stator disk itself is not shown and the air gap between the two rotors is enlarged to more easily demonstrate the unidirectional magnetic flux between the magnets.

FIG. 2A is a schematic diagram of the magnetic field between opposite magnetic pole plates. FIG. 2B is a schematic diagram of the magnetic field about a stator conductor (i.e. armature conducting coil) and the current direction (IN: into the page). FIG. 2C is a schematic diagram of the net magnetic field in the region between the magnetic plates as the magnetic plates move past the conductor inducing a current in the conductor.

FIG. 3A is a plane view of a disk rotor, according to a preferred embodiment of the invention, showing its permanent magnet elements. FIG. 3B is a sectional view taken on line 1′-1′ of FIG. 3A.

FIG. 4 is a partial elevational view of a disk stator and radially-oriented uninterrupted conductors wound on the surface of the disk stator, according to a preferred embodiment of the invention, showing the relative instantaneous position of the disk rotor magnets.

FIG. 5 is an expanded, developed and in-line, plane view of a disk stator and a radially-oriented uninterrupted conductor wound on a flat armature of nonmagnetic material, according to a preferred embodiment of the invention, showing the relative instantaneous position of the disk rotor magnets.

FIG. 6 is a plane view of a disk stator with an uninterrupted conductor coil, according to a preferred embodiment, showing the effective radial portions and the current induced in the conductor coil.

FIG. 7 is a cross-sectional view of a power disk alternator assembly, according to a preferred embodiment, showing multiple disk rotors stacked one on top of another forming small air gaps between them and disk stators located in the air gaps between the disk rotors.

FIG. 8 is an exploded isometric view of the power disk alternator assembly of FIG. 7.

FIG. 9 is an enlarged cross-sectional view of the power disk alternator assembly of FIG. 7, according to a preferred embodiment of the invention, showing three disk rotors (with their permanent magnet assemblies) and two disk stators (each with its at least one uninterrupted conductor) located in the gap between the disk rotors and illustrating the flow of the unidirectional magnetic field produced by the rotation of the disk rotor magnets and the current induced in the disk stator conductor. For clarity of view, the alternator housing and the stator disk itself is not shown, and the air gap between the two rotors is enlarged to more easily demonstrate the magnetic flux between the magnets.

### DESCRIPTION OF PREFERRED EMBODIMENTS

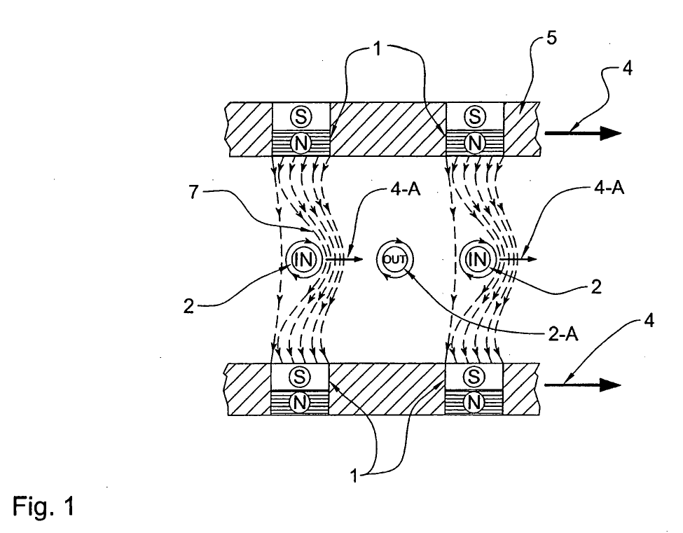

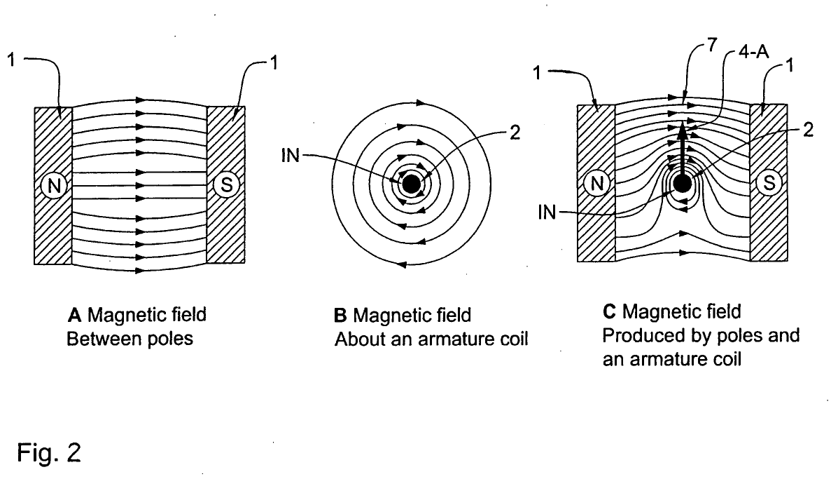

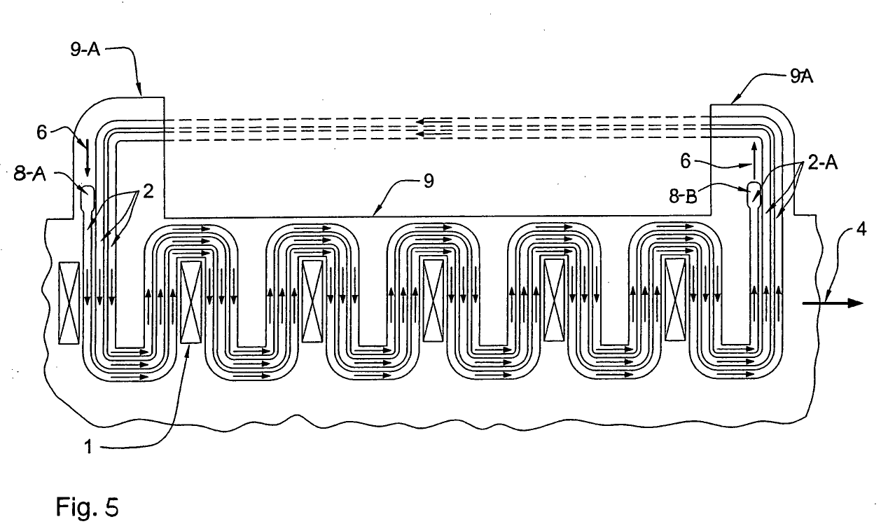

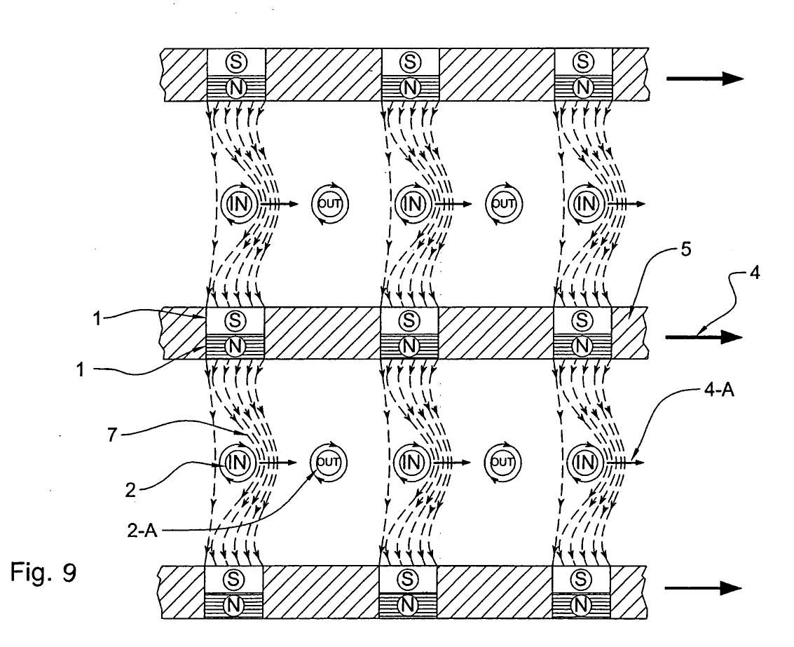

The present invention will be described more fully hereinafter with reference to the accompanying drawings, FIGS. 1 to 9, in which like numerals refer to like elements throughout.

A disk alternator according to the present invention is an axial-gap rotary electric generator comprising rotor and stator means designed to be direct driven, thus eliminating the need for costly gearboxes.

The rotor means comprises at least two rotating disks (i.e. disk rotors or rotor disks), each disk with a circular array of magnets arranged along the outer periphery in side-by-side relationship in a like polarity configuration. That is to say, the magnets of one disk are arranged side-by-side in a circular fashion with north (N) poles of the magnets disposed along the periphery of one surface of the rotor disk and south poles of the magnets disposed along the periphery of the opposite surface of the rotor disk. The disk rotors are “stacked” (i.e., arranged one over the other) keeping a gap between adjacent disks and aligning magnetic poles of one disk with the opposing magnetic poles of an adjacent disk (i.e., aligning the north (N) poles of one disk rotor with the south (S) poles of an adjacent disk rotor) creating a generally uniform unidirectional magnetic field between the opposite poles across the axial gap. Moreover, the magnetic fields thus created in the air gap between the rotor disks are all directed along the same axial direction.

The stator means includes at least one fixed disk (i.e. disk stator or stator disk) having a conductor path on at least one surface of the stator disk. The conductor path comprises a predetermined number of flat conductors, with no iron core, wound on one or both surfaces of the disk, with segments of the conductors directed radially outward from the center of the disk. The stator conductor disk is disposed fixedly in the gap formed by two rotating magnetic rotor disks. Preferably, the stator disk is also made of nonmetallic material such as thermally stable plastic.

The rotating magnetic rotor disks cause the unidirectional magnetic field in the gap to move in relation to the fixed conductor stator disk, inducing an alternating current in the conductors of the stator disk.

Connection means are provided for connecting the conductor path of the stator means to a load and outputting the generated ac current.

This alternator that produces an alternating current output is based, at least in part, upon the use of unique arrangement and configuration of permanent magnets and conductors with no iron core, and which have a markedly different physical and mechanical configuration as compared with conventional alternators. The present disk alternator is proposed to fulfill the need for a light-weight low speed alternator, mainly for installations like windmill power generators. Having an ironless core construction minimizes the weight and volume of the alternator and reduces the heat output through the reduction of core losses. Today's alternators must be operated at a relatively high speed to be efficient. However, as mentioned previously, industrial markets show a need for low speed alternators.

The invention disclosed herein maximizes the conversion of magnetic flux energy into electrical energy, and this from the energy stored in the interacting fields of the permanent magnets.

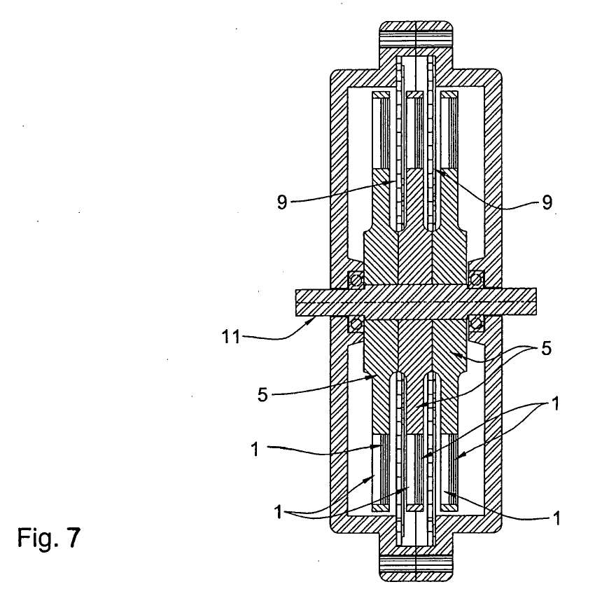

According to the alternator of the present invention, the rotor means comprises at least two rotating disks (i.e. disk rotors or rotor disks) (5). According to one embodiment of the invention, the rotor means may comprise two rotor disks (5), as shown in FIG. 1. According to another embodiment, the rotor means may comprise three rotor disks, as shown in FIGS. 7, 8, and 9.

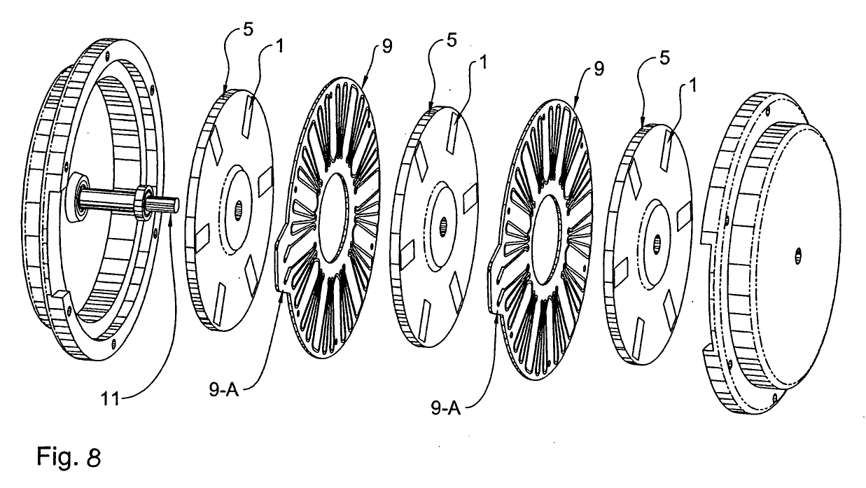

Referring to FIGS. 1, 7, 8, and 9, it is understood that the rotor means comprise two or more rotor disks (5) which are arranged to rotate about a central axis and a shaft (11) (shown in FIGS. 7 and 8) connected to an external power source that drives the shaft (11) which rotates the rotor disks (5) about the central axis in direction (4). The disk rotors (5) are arranged in such a way that they face each other and form a gap between them with a generally unidirectional uniform magnetic flux thereacross. The size of the air gap can be selectively adjusted using additional spacers placed along the shaft (11) of the alternator.

Each disk rotor (5) has a circular array of magnets (1), preferably permanent magnets, which are arranged in side-by-side relationship in a like polarity configuration disposed radially proximately along the outer periphery of the disk rotor (5), outwardly from the axis of the rotor (5). That is to say, north (N) poles of the magnets are disposed on one surface of the rotor disk while south poles of the magnets are disposed on the opposite surface of the rotor disk, as shown in FIGS. 1, 3A, 3B, and 9. The magnets (1) are preferably bar magnets, rectangular in shape as shown in the drawings. Nevertheless, the magnets (1) can be trapezoidal, oval, etc., any practical shape. The array of the magnetic elements (1) may be replaced by solid, generally arc-shaped members. It can be magnetized at an angle to its plane i.e. the magnetic fields can be angularly disposed relative to the plane of the arc-shaped member. The magnetic elements (1) may be replaced by a solid ring-shaped member which has several magnetic elements, each magnetic element isolated from the other by non-magnetic regions. In any case, magnets (1) of one rotor disk (5) face magnets (1) of the other rotor disk (5) of opposite polarity. Consequently, successively “stacked” rotor disks (5) have the south (s) pole of their magnets (1) facing the same direction, e.g. the south pole (S) of each rotor disk (5) faces a “top” side of the alternator whereas the north (N) pole of each rotor disk (5) faces an opposed “bottom” side of the alternator.

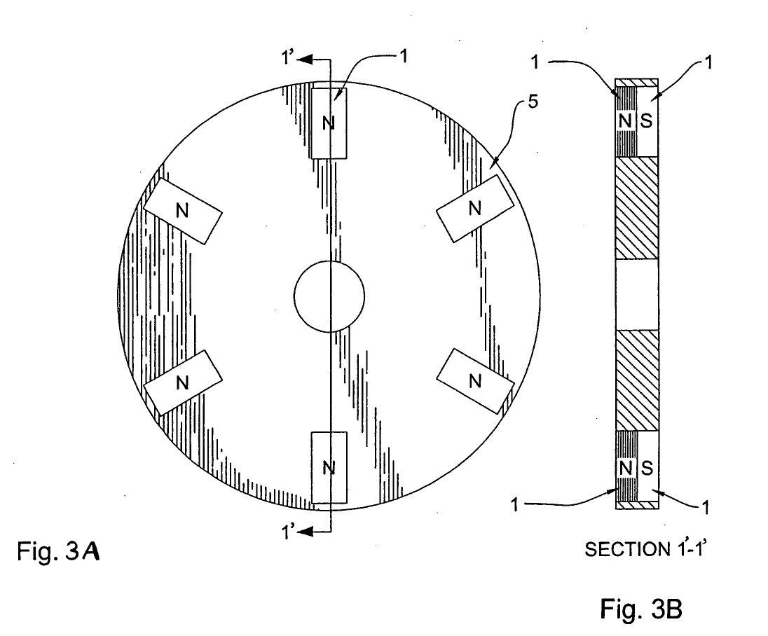

Preferably, the disk rotor (5) is made of non-metallic material, such as thermally stable plastic, to minimize the core losses and the weight of the alternator thereby maximizing power efficiency. Openings are provided in the plastic material of the disk to allow the insertion of the magnets (1). The thickness of the rotor disk (5) is determined by that of the magnets (1); the magnets (1) traverse the thickness of the rotor disk (5), as shown in FIGS. 1, 3A and 3B. In order to secure the magnets (1) to the rotor disk (5), thin thermo-setting bonding material, such as an epoxy, with or without supporting plastic sheets may be used to adhere the magnets (1) to the disk (5). This plastic bonding also helps to reduce windage and friction. The rotor disks (5) are affixed to the rotating shaft (11) using any appropriate assembly procedure.

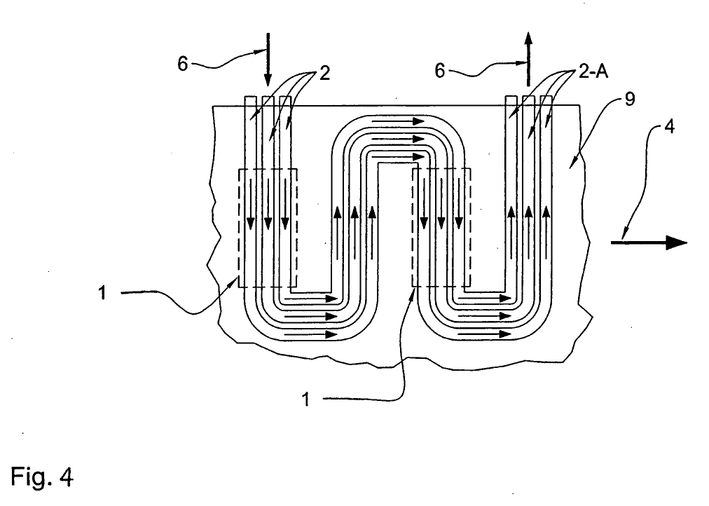

The stator means includes one fixed disk (i.e. disk stator or stator disk) (9) located in the gap between disk rotors (5) and having a conductor path on at least one surface of the disk stator (9), as shown in FIGS. 4, 5, and 6. Preferably, the disk stator (9) like the disk rotor (5) is made of non-metallic material, such as thermally stable plastic, to minimize the core losses and the weight of the alternator thereby maximizing power efficiency. The conductor path comprises at least one uninterrupted conductor wound on at least one surface of the stator disk (9).

The uninterrupted conductor may comprise several conductor components connected in series or a single continuous conducting component, such as a single continuous wire. It may include several radial conductor parts (2) and (2-A) extending from the center to the circumferential periphery of the surface of the stator disk (9) and several circumferential parts (illustrated in FIGS. 4, 5, and 6), where circumferential parts connect two radial parts together and preferably lie outside of the magnetic field. This is best shown in FIG. 4, where the dotted lines represent the magnets. In a preferred embodiment of the invention, the radial parts of the conductor are equally spaced.

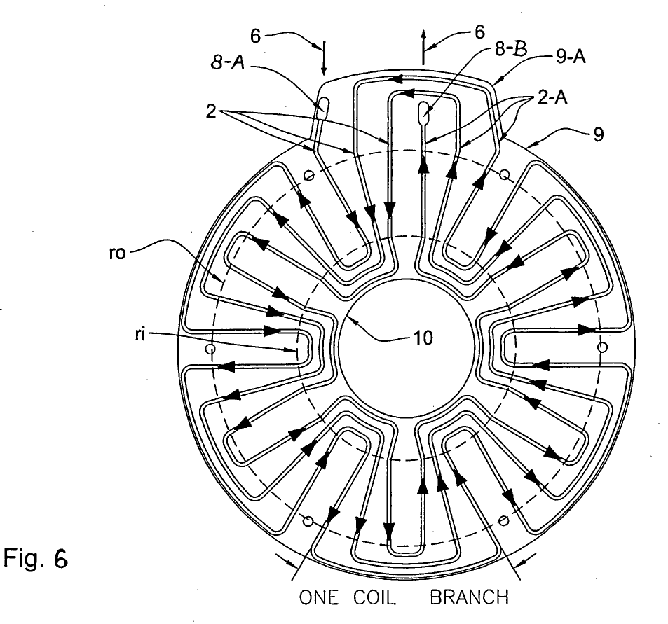

The radial conductor parts (2) and (2-A) are the effectively active parts of the conductor in the generation of electric current whereas the circumferential parts are effectively inactive. They are grouped into conductor coil branches, each coil branch having two potentially active radial conductor parts, (2) and (2-A), the induced current direction (6) in radial part (2) being opposite that of radial part (2-A), as shown in FIGS. 4, 5, and 6. The length of the radial conductor part defined by the outer radius (ro) and the inner radius (ri) in FIG. 6 is at least equal to the length of the magnets (1). Each conductor coil branch may include multiple radial conductor parts (2) and (2-A) to increase the effective length of the active radial parts moving through the magnetic fields (7) and consequently the emf generated. For example, as shown in FIGS. 4, 5, and 6, each conductor coil branch has three radial conductor parts (2) and three radial conductor parts (2-A). The spacing between radial conductor parts (2) and radial conductor parts (2-A) of each coil branch is essentially equal to the width of the magnets (1). In this way, only one half of each conductor coil branch, i.e. either the half comprising radial conductor parts (2) or the half comprising radial conductor parts (2-A), is covered by a magnet (1) at any given time, as shown in FIGS. 1, 4, 5, 6, and 9. The number of conductor coil branches in a stator disk (9), in this particular preferred embodiment, is six which equals the number of magnets (1) in rotor disk (5), as shown in FIGS. 4, 5, and 6. Of course, the number of conductor coil branches can vary, and is in part dependent on the available surface space.

Preferably, the conductor path and the conductor itself are flat. The flat conductors may be produced using printed circuit technology or thin film deposition in conjunction with a masking technique. The conductors may be placed on either or both sides of the stator disk (9). The effective conductor may comprise multiple identical (mirror) layers of conductors connected in series thereby increasing the effective total length of the active radial conductor parts (2) and (2-A) and the total emf induced.

Connection means (8-A) and (8-B) for connecting the conductor path of the stator disk (9) to a load are provided on either surface (top or bottom) of the extension tabs (9-A) of the stator disk (9), as shown in FIGS. 4, 5 and 6. The connection means consist of electric contacts of a shape that facilitates soldering leads, e.g. wires, to the load. Stator disk conductor paths may be connected either in parallel or in series to the load. Advantageously, these same contacts may be used to connect in series a conductor path located on one surface of the stator disk (9) to a conductor path located on the other opposite surface of the stator disk (9) or on the surface of an adjacent stator disk (using, for example, a conducting wire soldered to the appropriate contacts), thus increasing the overall length of the active conductor parts of the conductor path. The connection contacts provided on the stator disk tabs (9-A) do not rotate, i.e. are fixed, and for this reason the alternator does not require slip rings for connection to the external load.

It should be understood that more of such stator-rotor units may be used as necessary or desirable. Such assemblies may utilize the standard rotor and stator disks produced by mass production means, and they may be stacked together to increase the power supplied by the alternator. The automated mass-assembly of stator-rotor units is facilitated and thus made cost-efficient by the fact that every rotor disk (5) in the alternator of the present invention is oriented in the same direction, the north (N) poles of the rotor disks (5) all face the same direction, e.g. “up”. The rotors are easily identically arranged one over the other, the surface of the rotor disk on which the north (N) magnetic poles are exposed faces the surface of the adjacent rotor disk on which the south (S) magnetic poles are exposed. Also, the rotor disks (5) may be rotatably supported by bearings mounted in the housing of the alternator and two fixed stator disks (9), as shown in FIGS. 7 and 8—the stator disk (9) has an opening (10), the diameter of which is larger than the rotor disk's (5) central hub, and tabs (9-A) which can engage fixedly the housing.

The principle of the present invention is illustrated in FIGS. 1, 2, and 9.

As the rotor disks are driven in simultaneous rotation (4), they sweep their axial unidirectional uniform magnetic fields (7)—produced by the alignment of the north (N) poles of the magnets (1) of one rotor disk with the south (S) poles of the magnets (1) of an adjacent rotor disk—across the stationary conductor parts (2) and (2-A) of the conductor coil branches mounted on the flat non-ferrous stator disk (not shown in FIGS. 1, 2, and 9 for sake of clarity). As the magnetic field (7) (with the direction as shown in FIGS. 1, 2 and 9) sweeps past the conductor parts (2), it induces an emf across the conductor parts (2). When the circuit defined by the conductor path of the stator disk is complete (closed) through connection to an external load, the emf induces a current in the conductors (2) whose direction is into the page. The induced emf in an electric circuit always acts in such a direction that the current it drives around the circuit opposes the change in magnetic flux which produces the emf. The induced current of conductor part (2) sets up a (induced) magnetic field which opposes the change in magnetic flux, depicted by the magnetic field lines circulating the counductor part (2). This induced magnetic field exerts a force on the magnetic field (7) of the rotors in the direction (4-A), which is the same direction as the motion (4) of the rotor disks (5) and hence reinforces the motion of the rotor disks (5). As the magnets (1) sweep across conductor parts (2), conductor part (2-A) is located between magnetic poles and hence in a region of negligible or zero magnetic field. The current through conductor part (2-A) is that flowing from conductor part (2) and is therefore directed out of the page. The current in conductor part (2-A) also sets up a magnetic field around the conductor part (2-A), as shown by the circular magnetic field lines about conductor part (2-A) in FIGS. 1, 2 and 9. However, conductor part (2-A) is in a region where there is practically no external magnetic field (i.e. the magnetic field due to the rotor disks (5) is practically zero) to interact with the magnetic field of the conductor part (2-A). As such, this part of the conductor coil branch does not interact with the magnetic field (7) of the rotor disks (5). As the magnetic field (7) sweeps past conductor part (2) and across conductor part (2-A), the induced current is reversed. That is to say, conductor part (2-A) now interacts with the magnetic field (7) and the current induced in conductor part (2-A) is directed into the page. At the same time, conductor part (2) is in the region where the external field is virtually zero and the current flowing through conductor part (2) is that due to conductor part (2-A) and is directed into the page. And so, as the magnetic field (7) sweeps across the conductor parts (2) and (2-A) it induces an alternating (ac) current.

The alternator of the present invention can produce multiphase ac current, which means that the voltages (emf) generated in the stator disk (9) conductors can rise and fall at different times, a voltage generated in one conductor may be rising while a voltage (emf) generated in another is falling. The stator disks (9) can also be connected in a “star” configuration, with all the starts placed together and the ac output taken from the finish tails. Connecting these tails to a rectifier allows the conversion from alternating current (ac) to direct current (dc).

The instantaneous value of the induced emf will depend on the instantaneous magnitude of the tangential velocity of the magnetic field with respect to the conductor. If the angular velocity of the magnets (1) of the rotor disks (5) doubles then the induced emf doubles. Likewise, if the magnitude (strength) of the magnetic field (7) increases, then the induced emf also increases. Therefore, by using the same revolutions per minute (rpm) but increasing the radial distance of the rotor magnets and stator conductors from the central axis, it is possible to increase the induced emf without increasing the rpm since the tangential velocity is dependent on both the angular velocity and the radial distance from the axis of rotation. In addition, by ensuring the proper alignment of the rotor disks (5) with respect to the stator disks (9), as well the proper alignment of the stator disk conductors connected in series, the emf generated will be maximized, equal to integral sum of the emf induced over the active parts of the conductors. Furthermore, the multiple magnetic poles of the rotor disks (5) enable a sufficiently high ac frequency to be attained without an unduly high rpm for the rotor disks (5).

While this invention has been described as having preferred embodiments, it will be understood that it is capable of further modifications in the shape of the stator conductor disk and rotor magnetic disk and their orientation with respect to each other. Further modifications may be made in the construction materials for magnetic elements or otherwise to enhance operation or reliability or to reduce the cost. Accordingly, while the invention has been described with reference to specific configurations, it is to be understood that this disclosure is to be interpreted in its broadest sense and to encompass the use of equivalent apparatus.

Moreover, given that the theory of a generator is similar to that of a motor, (a motor converting electrical energy into mechanical energy), the present invention can be used “in reverse” as a motor.

Therefore this application is to cover any variation, use or adaptation of the invention following the general principle thereof and including such departures as come within known or customary practice in the art to which this invention pertains and falls within the limits of the appended claims.

1. A power disk alternator comprising:
rotor means arranged to rotate about an axis, having a circular cross section, and comprising at least two disks facing each other and defining at least one gap therebetween, said rotor means having a shaft connected to an external source for driving the shaft in rotation about said axis;
a circular array of magnetized elements located in equally arcuately spaced relation adjacent to the periphery of each disk of said rotor means, each of said magnetized elements having surfaces of opposite polarity and being disposed in side-by-side relationship in a like polarity configuration, magnetized elements of one disk facing magnetized elements of the other disk of opposite polarity to create between the two disks in the air gap the magnetic fields between the opposite polarities; and
stator means comprising at least one fixed disk made of a nonmetallic material having a conductor path on at least one surface thereof, said conductor path comprising at least one uninterrupted conductor wound on said surface, each of said stator means being located in one of said at least one air gap; and
connection means for connecting said conductor path to a load,
wherein when said external source drives said shaft of said rotor means in rotation about said axis, said rotor means rotates and the resulting rotating magnetic field induces a current in said conductor path of said stator means.

2. The power disk alternator according to claim 1, wherein said at least two disks of said rotor means are oriented identically.

3. The power disk alternator according to claim 1, wherein said disks of said rotor means are adjustable to selectively vary the size of each of said at least one air gap.

4. The power disk alternator according to claim 1, wherein said disks of said rotor means are made of non-metallic material.

5. The power disk alternator according to claim 4, wherein said disks of said rotor means are made of thermally stable, rigid plastic.

6. The power disk alternator according to claim 1, wherein said magnetic elements traverse the thickness of the rotor disk.

7. The power disk alternator according to claim 1, wherein said at least one uninterrupted conductor comprises a plurality of radial portions extending from the center to the circumferential periphery of the at least one fixed disk, said radial portions being equally spaced and connected in series.

8. The power disk alternator of claim 1, wherein said at least one uninterrupted conductor comprises a plurality of conductors connected in series.

9. The power disk alternator of claim 1, wherein said at least one uninterrupted conductor comprises a single conducting component.

10. The power disk alternator according to claim 1, wherein said conductor path is flat.

11. The power disk alternator according to claim 1, wherein said at least one conductor is produced using thin film deposition techniques.

12. The power disk alternator according to anyone of claims 1, wherein each of said at least one uninterrupted conductor is connected to each other.

13. The power disk alternator according to anyone of claims 1, wherein said at least one fixed disk of said stator means are made of thermally stable rigid plastic.

14. The power disk alternator according to claim 1, wherein said alternator comprises three rotor disks and two stator disks, a stator disk being located in each of said air gaps.

15. The power disk alternator according to claim 1, wherein said alternator comprises a number of rotor disks and a number less one stator disks, a stator disk being located in each of said air gaps.
